(19) United States
(12) Patent Application Publication
(10) Pub. No.: US 2006/0151278 A1
(43) Pub. Date: Jul. 13, 2006

(54) REDUCED AXIAL LENGTH AIR ACTUATED CONE CLUTCH FAN DRIVE

(75) Inventor: Samuel E. Settineri, Marshall, MI (US)

Correspondence Address: BorgWarner Inc.;Patent Administrator, 3850 Hamlin Road, Auburn Mills, MI, 48326-2872, US

(73) Assignee: BORGWARNER, INC., Auburn Hills, MI (US)

(21) Appl. No.: 10/905,505

(22) Filed: Jan. 7, 2005

(51) Int. Cl. F16D 25/0632; F16D 13/26

(52) U.S. Cl. 192/91 A; 192/66.22; 192/89.27; 192/110 B

(57) ABSTRACT

A clutch assembly is provided comprising a clutch housing having a clutch housing length. A central piston chamber is positioned therein and feeds a pressure chamber. A translatable clutch piston is in communication with the pressure chamber and is movable between a piston neutral position and a piston activated position in response to air pressure fed into the pressure chamber. A rotating drive shaft is positioned within the clutch housing. A cone clutch element is moved from a clutch engaged position to a clutch disengaged position in response to the translatable clutch piston moving from the piston neutral position to the piston activated position. The cone clutch element engages the rotating drive shaft when in the clutch engaged position. A clutch spring biases the cone clutch element into the clutch engaged position with a clutch engagement force. The clutch spring has a primary spring ratio of a wire diameter to a spring diameter optimized such that a maximum spring force is achieved while minimizing the spring length.

### TECHNICAL FIELD

The present invention relates generally to a reduced axial length fan clutch and more particularly to a method of optimizing clutch components for minimization of axial length.

### BACKGROUND OF THE INVENTION

Vehicle engines commonly utilize cooling assemblies to remove excess heat from the engine and maintain an optimal operating temperature. The cooling assembly pumps a coolant through the engine and other components in order to control engine temperature. Heat generated within the engine and other components is absorbed by the coolant and dispersed into the surrounding atmosphere through the use of a radiator. In order to improve dispersal by the radiator, it is common to utilize fan assemblies to draw or force air past the radiator to assist in temperature transmission.

It is not always desirable for such fan assemblies to be run continuously. At times, it is desirable for the temperature within the coolant to increase rather than decrease. Additionally, continuous operation when unnecessary places an non-required draw on the engine and thereby reduces efficiency. To compensate for this, present fan assemblies utilize fan clutch assemblies that allow for the selective engagement of the fan to the engine such that the fans are engaged only when necessary. The fan clutch assemblies may be operated in a host of configurations including hydraulic and air-pressure actuated. It is common for these systems to be biased towards fan operation such that when failure occurs in the clutch assembly, the fan continuously operates to keep the engine cool.

An issues with these fan assemblies and associated clutch assemblies stems from their location within the engine compartment. These assemblies must share space within the compartment with a wide variety of engine related systems. The assemblies, therefore, can be placed under severe dimensional restraints. However, fan clutch drives are commonly dimensionally constrained by the internal workings of the clutch which limits reduction of the drive assembly. This dimensional constraint, especially realized in clutch length, limits the applications wherein a pneumatic clutch can be utilized.

It would therefore be highly desirable to have pneumatic clutch fan assembly with a unique internal design wherein reduction in clutch length could be realized. It would further be highly desirably for such a reduced length clutch assembly to provide performance optimized while length is minimized.

### SUMMARY OF THE INVENTION

It is therefore an object to the present invention to provide an clutch assembly with a minimized clutch housing length. It is further an object of the present invention to provide a clutch assembly utilizing a clutch spring optimized for maximum spring force while minimizing spring length.

In accordance with the objects of the present invention a clutch assembly is provided comprising a clutch housing having a clutch housing length. A central piston chamber is positioned therein and feeds a pressure chamber. A translatable clutch piston is in communication with the pressure chamber and is movable between a piston neutral position and a piston activated position in response to air pressure fed into the pressure chamber. A rotating drive shaft is positioned within the clutch housing. A cone clutch element is moved from a clutch engaged position to a clutch disengaged position in response to the translatable clutch piston moving from the piston neutral position to the piston activated position. The cone clutch element engages the rotating drive shaft when in the clutch engaged position. A clutch spring biases the cone clutch element into the clutch engaged position with a clutch engagement force. The clutch spring has a primary spring ratio of a wire diameter to a spring diameter optimized such that a maximum spring force is achieved while minimizing the spring length.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of cone clutch fan drive in accordance with the present invention, the clutch assembly illustrated in the clutch disengaged position.

FIG. 2 is an illustration of cone clutch fan drive in accordance with the present invention, the clutch assembly illustrated in the clutch engaged position.

### DESCRIPTION OF PREFERRED EMBODIMENTS

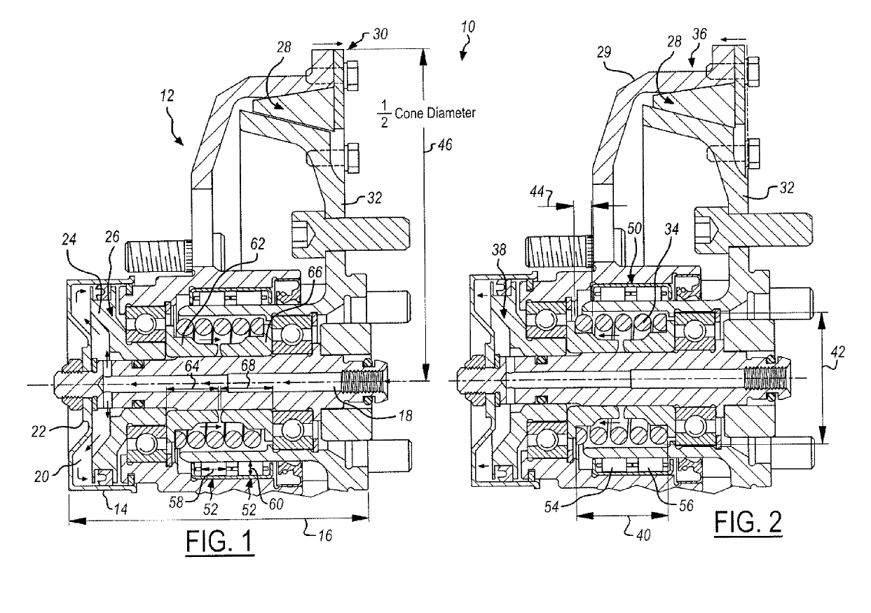

Referring now to FIG. 1 which is a cone clutch fan drive assembly 10 in accordance with the present invention. The fan drive assembly 10 includes a clutch assembly 12 consisting of a clutch housing 14 having a clutch housing length 16 (housing length). The present invention provides novel and valuable improvements to the clutch assembly 12 that allow for the minimization of the clutch housing length 16, which in turn allows the clutch fan drive assembly 10 to be utilized in a wide variety of automotive applications while providing minimal impact on surrounding structures.

The clutch assembly 12 includes a central piston chamber 18 positioned within the clutch housing 14. Preferably positioned along the centerline of the drive assembly 10, the central piston chamber 18 provides a pathway through the clutch assembly 12 through which pressurized air may be selectively passed. The pressurized air passes through the central piston chamber 18 and into a pressure chamber 20 formed between a chamber cap 22 and a translatable clutch piston 24. When air pressure is supplied, the pressure chamber 20 becomes pressurized and the translatable clutch piston 24 is moved into a piston activated position 26. In this position 26 (shown in FIG. 1), the translatable clutch piston 24, which is in communication with a cone clutch element 28, moves the cone clutch element 28 into a clutch disengaged position 30. The cone clutch element 28, or friction liner, is attached to a steel housing 29 which, in turn, is attached to the translatable clutch piston. When in the clutch disengaged position 30, the cone clutch element 28 disengages from the rotating drive shaft 32 such that the rotating drive shaft 32 rotates independently from the cone clutch element 28.

The present invention, however, further includes a clutch spring 34 positioned within the clutch housing 14 that biases the cone clutch element 28 into a clutch engaged position 36 (see FIG. 2). When pressure within the pressure chamber 20 is released, the clutch spring 34 moves the cone clutch element 28 into the clutch engaged position 36 and the translatable clutch piston 24 moves into the piston neutral position 38. The clutch spring 34 also provides a maximum spring force which in turn translates into a clutch engagement force between the cone clutch element 28 and the rotating drive shaft 32. This is an important force as it prevents slippage between the clutch 28 and the drive shaft 32. As this maximum spring force is necessary for proper operation, standard clutch springs 34 have been found to require a minimum spring length 40 in order to produce the desired clutch engagement force. This, in turn, makes it difficult to reduce the clutch housing length 16 to improve packaging considerations.

The present invention provides a unique approach to this dilemma. The present invention increases the spring diameter 42 while reducing the wire diameter 44 of the clutch spring 34 such that a maximum spring force is achieved over a minimum spring length 40. Research has determined that the primary spring ratio of wire diameter 44 to spring outer diameter 42 is preferably less than 0.14 and is preferably approximately 0.134 in order to provide proper spring force over a suitable spring length 40. Additionally, by allowing the maximum spring force in this configuration to be approximately equal to two thirds of the maximum stress the spring can experience (in the fully compressed state), the present configuration provides the minimally required clutch engagement force over the lifetime of the cone clutch fan drive assembly 10. Reduction of clutch length without alteration of spring diameter can result in stresses exceeding the spring wire maximum limit of two-third yield strength. By increasing diameter 42, the stresses may be maintained below the two-thirds limit. This large diameter and shortened length clutch spring 34 preferably results in a secondary spring ratio of spring length 40 to spring diameter 42 less than 1.0 and is preferably 0.68. These dimensional constraints allow for a significant reduction in clutch housing length 16 without a reduction in clutch performance. In one embodiment, the clutch housing length 16 was reduced by as much as 0.6 inches.

The present invention in addition utilizes a unique needle bearing package 50 positioned in between the rotating drive shaft 32 and the cone clutch element 28. The needle bearing package 50 is comprised of a dual needle bearing assembly 52 having a first needle bearing 54 and a second needle bearing 56. It is noted that the reduction in spring length 40 places additional heat and wear on the bearing package 50. The present invention addresses this by making sure that each of the needle bearings 54, 56 includes a bearing length 58 and a bearing height 60. The ratio of the bearing length 58 to bearing height 60 being less that 3 to 1 and is preferably 2 to 1. This was determined to prevent bearing overheating and wear that may be produced through the reduction of clutch housing length 16 and additional part shortening.

It should be noted that the present invention reduces the spring rate to approximately 387 lbs/inch. This results in a smaller drop off in clutch capacity as the friction liner 28 wears and the spring 34 stretches. It is known that clutch 12 travel, between clutch engaged position 36 and clutch disengaged position 30, may increase over clutch life from approximately 0.05 inches new to 0.160 inches at end of life. The present invention reduces spring rate and design such that this increase in travel results in a reduction in spring force loss between new and used. This reduction in spring drop-off is highly beneficial.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A clutch assembly for a fan drive system of an engine comprising:
a clutch housing, said clutch housing comprising a clutch housing length;
a central piston chamber feeding a pressure chamber;
a translatable clutch piston positioned within said clutch housing and in communication with said pressure chamber, said translatable clutch piston movable between a piston neutral position and a piston activated position, wherein air pressure fed through said central piston chamber into said pressure chamber moves said translatable clutch piston between said piston neutral position to said piston activated position;
a rotating drive shaft positioned within said clutch housing;
a cone clutch element in communication with said translatable clutch piston such that said cone clutch element is moved from a clutch engaged position to a clutch disengaged position in response to said translatable clutch piston moving from said piston neutral position to said piston activated position, said cone clutch element engaging said rotating drive shaft when in said clutch engaged position;
a clutch spring positioned between said rotating drive shaft and said cone clutch element, said clutch spring biasing said cone clutch element into said clutch engaged position with a clutch engagement force, said clutch spring having a spring length, a maximum spring force, a wire diameter, and a spring diameter, a primary spring ratio of said wire diameter to said spring diameter optimized such that said maximum spring force is achieved while minimizing said spring length; and
a needle bearing package positioned between said rotating drive shaft and said cone clutch element.

2. A clutch fan assembly as described in claim 1, wherein said needle bearing package comprises:
a dual needle bearing assembly including a first needle bearing and a second needle bearing, each of said needle bearings having a bearing length and a bearing height, the ratio of said bearing length to said bearing height being less than 3 to 1.

3. A clutch fan assembly as described in claim 1, wherein said spring ratio is less than 0.14.

4. A clutch fan assembly as described in claim 2, wherein said ratio of said bearing length to said bearing height is approximately 2 to 1.

5. A clutch fan assembly as described in claim 1, wherein said spring length to said spring diameter generates a secondary spring ratio less than 1.0.

6. A clutch fan assembly as described in claim 1, wherein said clutch spring comprises a spring rate adapted to minimize spring force loss over the lifespan of said cone clutch element.

7. A clutch fan assembly as described in claim 5, wherein said spring length to said spring diameter generates a secondary spring ratio approximately equal to 0.68.

8. A clutch fan assembly as described in claim 1, further comprising: a housing length to cone diameter ratio of approximately 46 percent.

9. A clutch assembly for a fan drive system of an engine comprising:
a clutch housing, said clutch housing comprising a clutch housing length;
a central piston chamber feeding a pressure chamber;
a translatable clutch piston positioned within said clutch housing and in communication with said pressure chamber, said translatable clutch piston movable between a piston neutral position and a piston activated position, wherein air pressure fed through said central piston chamber into said pressure chamber moves said translatable clutch piston between said piston neutral position to said piston activated position;
a rotating drive shaft positioned within said clutch housing;
a cone clutch element in communication with said translatable clutch piston such that said cone clutch element is moved from a clutch engaged position to a clutch disengaged position in response to said translatable clutch piston moving from said piston neutral position to said piston activated position, said cone clutch element engaging said rotating drive shaft when in said clutch engaged position;
a clutch spring positioned between said rotating drive shaft and said cone clutch element, said clutch spring biasing said cone clutch element into said clutch engaged position with a clutch engagement force, said clutch spring having a spring length, a maximum spring force, a wire diameter, and a spring diameter, a primary spring ratio of said wire diameter to said spring diameter below 0.14 such that said maximum spring force is achieved while minimizing said spring length;
wherein said clutch housing length is minimized corresponding to said minimized spring length.

10. A clutch fan assembly as described in claim 9, further comprising:
a dual needle bearing assembly including a first needle bearing and a second needle bearing, each of said needle bearings having a bearing length and a bearing height, the ratio of said bearing length to said bearing height being less than 3 to 1, said dual needle bearing assembly positioned between said rotating drive shaft and said cone clutch element.

11. A clutch fan assembly as described in claim 10, wherein said ratio of said bearing length to said bearing height is approximately 2 to 1.

12. A clutch fan assembly as described in claim 9, wherein said spring length to said spring diameter generates a secondary spring ratio less than 1.0.

13. A clutch fan assembly as described in claim 9, wherein said maximum spring force is approximately 66 percent of a spring maximum stress.

14. A clutch fan assembly as described in claim 12, wherein said spring length to said spring diameter generates a secondary spring ratio approximately equal to 0.68.

15. A clutch fan assembly as described in claim 9, further comprising: a housing length to cone diameter ratio of approximately 46 percent.

16. A method of shortening a clutch fan assembly for use in a fan drive system of an engine comprising:
increasing a spring diameter and decreasing a wire diameter of a clutch spring such that a maximum spring force is achieved in a minimum spring length;
reducing a clutch housing length of a clutch housing to accommodate said minimum spring length;
positioning a central piston chamber that feeds a pressure chamber within said clutch housing;
moving a translatable clutch piston positioned within said clutch housing and in communication with said pressure chamber between a piston neutral position and a piston activated position by way of air pressure fed through said central piston chamber into said pressure chamber;
rotating a drive shaft positioned within said clutch housing;
moving a cone clutch element from a clutch engaged position to a clutch disengaged position in response to said translatable clutch piston moving from said piston neutral position to said piston activated position;
engaging said rotating drive shaft with said cone clutch element when in said clutch engaged position;
biasing said cone clutch element into said clutch engaged position using said clutch spring positioned between said rotating drive shaft and said cone clutch element.

17. A method as described in claim 16, further comprising:
reducing a primary spring ratio of said wire diameter to said spring diameter below 0.14 such that a maximum spring force is achieved while minimizing said spring length.

18. A method as described in claim 16, further comprising:
optimizing said maximum spring force at two thirds of a spring maximum stress.

19. A method as described in claim 16, further comprising:
reducing a secondary spring ratio consisting of said spring length to said spring diameter to less than 0.7.

20. A method as described in claim 16, further comprising:
reducing the rate of said bearing length to said bearing height to less than 3 to 1.
